(19) United States
(12) Patent Application Publication
(10) Pub. No.: US 2015/0127126 A1
(43) Pub. Date: May 7, 2015

(54) EXERCISE AMOUNTS CALCULATION METHOD, EXERCISE AMOUNTS CALCULATION DEVICE, AND PORTABLE APPARATUS

(71) Applicant: Seiko Epson Corporation, Shinjuku-ku (JP)

(72) Inventors: Yoshitaka YAMAGATA, Matsumoto-shi (JP); Yoshiyuki MURAGUCHI, Shiojiri-shi (JP); Hiroyuki ISOGAI, Chino-shi (JP); Tomoya KAWAMOTO, Shiojiri-shi (JP); Tatsuhiko SUGIYAMA, Shiojiri-shi (JP); Naoki GOBARA, Shiojiri-shi (JP)

(21) Appl. No.: 14/530,326

(22) Filed: Oct. 31, 2014

(30) Foreign Application Priority Data
Nov. 5, 2013 (JP) 2013-229329
Aug. 6, 2014 (JP) 2014-160180

(51) Int. Cl. G06K 9/00; A63B 71/06

(52) U.S. Cl. CPC G06K 9/00342; A63B 71/06
USPC 700/91

(57) ABSTRACT

A determination unit determines a first direction appearing in the distribution of a detected acceleration by an acceleration sensor which configured to be worn on a body of a user. A calculation unit calculates exercise amounts during a moving exercise of the user using a variation cycle of the value of the detected acceleration along the first direction.

### BACKGROUND

1. Technical Field

The present invention relates to an exercise amounts calculation method using an acceleration sensor, an exercise amounts calculation device, and a portable apparatus including the same.

2. Related Art

A portable electronic apparatus (hereinafter, referred to as “portable apparatus”) which has a positioning function using a global positioning system (GPS) or the like is known, and a portable apparatus, called “running watch”, “training watch”, “runner's watch”, or the like mounted on one of the four limbs, such as an arm or a leg of a user is known (for example, JP-A-2013-140158).

In this portable apparatus, if the user performs an operation to start a measurement, position measurement information including latitude, longitude, or the like, speed information, moving distance information, pitch information, or the like is measured and displayed periodically.

The pitch information which is one of the exercise amounts of the user during a moving exercise is represented as, for example, the number of steps (PPM: Paces Per Minute) per minute, and is generally calculated by detecting the peak of a detected acceleration by the acceleration sensor embedded in the portable apparatus.

However, when the portable apparatus is mounted on one of the four limbs of the user, the peak of the detected acceleration by the acceleration sensor may include a peak other than landing during each step. That is, for example, when the portable apparatus is mounted on an arm, a large acceleration is detected at the time of landing, and a large acceleration is detected at the time of change of the back-and-forth motion of the arm. For this reason, it is difficult to detect only the peak at the time of landing in the detected acceleration, and an error may be included in the pitch to be calculated.

For example, although the pitch has been illustrated as one of the exercise amounts of the user during the moving exercise, a similar problem exists with a grounding index value, such as impact at the time of landing or a force when striking the ground.

### SUMMARY

An advantage of some aspects of the invention is to implement a technique which enables calculation of exercise amounts during a moving exercise of a user with higher precision using a detected acceleration by an acceleration sensor attached to a body (in the example of the related art, “one of the four limbs”) of the user.

A first aspect of the invention is directed to an exercise amounts calculation method including finding a first direction appearing in the distribution of a detected acceleration by an acceleration sensor attached to a body of a user, and calculating exercise amounts during a moving exercise of the user using a variation cycle of the value of the detected acceleration along the first direction.

As another aspect of the invention, the invention may be configured as an exercise amounts calculation device including a determination unit which finds a first direction appearing in the distribution of a detected acceleration by an acceleration sensor attached to a body of a user, and a calculation unit which calculates exercise amounts during a moving exercise of the user using a variation cycle of the value of the detected acceleration along the first direction (seventh aspect of the invention).

According to the first aspect (or the seventh aspect), the first direction appearing in the distribution of the detected acceleration by the acceleration sensor attached to the body of the user, for example, one of the four limbs of the user is determined, and the exercise amounts are calculated using the variation cycle of the value of the detected acceleration along the first direction. For example, the acceleration at the time of landing changes largely during the moving exercise of the user, and the four limbs of the user move forth and back during the moving exercise of the user to cause periodic change in acceleration. Accordingly, the distribution of the detected acceleration includes two directions of the up-and-down direction of the body of the user and the direction relating to the back-and-forth motion of the four limbs. However, as described in an embodiment described below, it is understood that the two directions are represented as different scattering directions in the distribution of the detected acceleration. For this reason, it is possible to determine either of the two directions from the distribution of the detected acceleration. Then, it is possible to calculate the exercise amounts using the variation cycle of the value of the detected acceleration along the determined direction (first direction). Therefore, it is possible to calculate the exercise amounts during the moving exercise of the user with higher precision.

A second aspect of the invention is directed to an exercise amounts calculation method according to the first aspect, which further includes autocorrelating a plurality of values of the detected acceleration varying along the first direction to calculate the variation cycle.

According to the second aspect, it is possible to calculate the variation cycle from the value of the detected acceleration varying along the first direction. At this time, since the variation cycle is found using autocorrelation, it is possible to calculate a more accurate variation cycle. The variation cycle is, for example, a period or a frequency, and corresponds to a pitch which is one of the exercise amounts. If the user performs a moving exercise, such as walking or running, the acceleration along the first direction changes periodically, whereby it is possible to more accurately calculate the variation cycle by autocorrelation.

A third aspect of the invention is directed to the exercise amounts calculation method according to the second aspect, wherein the autocorrelating includes performing predetermined frequency analysis processing and performing predetermined inverse frequency analysis processing.

According to the third aspect, it is possible to perform the autocorrelation using the predetermined frequency analysis processing and the predetermined inverse frequency analysis processing, whereby it is possible to reduce the amount of calculation.

A fourth aspect of the invention is directed to the exercise amounts calculation method according to any of the first to third aspects, wherein the finding of the first direction includes finding the first direction based on a scattering direction of the distribution of the detected acceleration.

According to the fourth aspect, it is possible to find the first direction based on the scattering direction of the distribution of the detected acceleration.

A fifth aspect of the invention is directed to the exercise amounts calculation method according to the fourth aspect, wherein the finding of the first direction includes finding the first direction based on one of a maximum scattering direction of the distribution of the detected acceleration and a scattering direction orthogonal to the maximum scattering direction.

According to the fifth aspect, it is possible to find the first direction based on one of the maximum scattering direction of the distribution of the detected acceleration and the scattering direction orthogonal to the maximum scattering direction. The maximum scattering direction is a direction having the largest spreading width as the spread of the distribution of the detected acceleration. The maximum scattering direction and the scattering direction orthogonal to the maximum scattering direction correspond to one of the up-and-down direction of the body of the user and the direction relating to the back-and-forth motion of the four limbs. For this reason, it is possible to more accurately specify the first direction.

A sixth aspect of the invention is directed to the exercise amounts calculation method according to any of the first to fifth aspects, wherein the finding of the first direction includes finding the first direction which appears in the distribution of the detected acceleration for a predetermined unit time equal to or less than five seconds.

According to the sixth aspect, the first direction is found from the distribution of the detected acceleration for the predetermined unit time equal to or less than five seconds. For this reason, it is possible to reduce the amount of data when finding the first direction.

An eighth aspect of the invention is directed to the exercise amounts calculation device according to the seventh aspect, wherein the acceleration sensor is attached to one of the four limbs of the user.

According to the eighth aspect, the first direction appearing in the distribution of the detected acceleration by the acceleration sensor attached to one of the four limbs of the user is determined, and it is possible to calculate the exercise amounts using the variation cycle of the value of the detected acceleration along the determined first direction. Accordingly, it is possible to calculate the exercise amounts during the moving exercise of the user with higher precision.

A ninth aspect of the invention is directed to a portable apparatus including the exercise amounts calculation device according to the seventh or eighth aspect.

According to the ninth aspect, since the portable apparatus includes the exercise amounts calculation device according to the above-described aspects, when the portable apparatus is mounted on one of the four limbs or another part of the body to carry out speed estimation, it is possible to perform speed estimation of the user while preventing the influence of the attachment method of the portable apparatus or the influence of an individual difference, such as the movement of the four limbs of the user or the form of the operation, or an abnormal operation.

Accordingly, it is possible to provide a portable apparatus capable of measuring the moving speed of the user with the portable apparatus with high precision.

### BRIEF DESCRIPTION OF THE DRAWINGS

The invention will be described with reference to the accompanying drawings, wherein like numbers reference like elements.

FIG. 1 is a block diagram showing a primary configuration example of a running watch.

FIG. 2 is a block diagram showing a configuration example of a processing unit constituting the running watch.

FIG. 3 is a flowchart showing a processing procedure of speed estimation processing.

FIG. 4 is a flowchart showing a detailed processing procedure of acceleration distribution analysis processing.

FIG. 5 is a diagram showing first principal component data (PCA1) for the last two seconds.

FIG. 6 is a diagram showing an autocorrelation processing result of first principal component data (PCA1) of FIG. 5.

FIG. 7 is a flowchart showing a detailed processing procedure of autocorrelation processing as frequency analysis processing.

FIG. 8 is a flowchart showing a detailed processing procedure of state determination processing.

FIGS. 9A to 9C are explanatory views showing three typical states of a user.

FIG. 10 is a diagram illustrating a processing procedure of learning processing.

FIG. 11 is a diagram showing a data configuration example of learning data.

FIG. 12 is a diagram illustrating a least squares method.

### DESCRIPTION OF EXEMPLARY EMBODIMENTS

Hereinafter, a mode for carrying out an exercise amounts calculation method and an exercise amounts calculation device of the invention will be described referring to the drawings. In the following description, a running watch is illustrated as a portable apparatus including an exercise amounts calculation device. The running watch is used in a state of being mounted on a wrist of a user, and periodically measures and displays positional information or speed information of the user, pitch information, distance information, or the like. In this embodiment, although an example where speed and pitch information are calculated as an example of exercise amounts will be specifically described, the invention can be of course applied to the calculation of other feature amounts. For example, a grounding index value, such as impact at the time of landing or a force when striking the ground, may be calculated. It should be noted that the invention is not limited to the following embodiment, and a mode to which the invention is applicable is not limited to the following embodiment. In the drawings, the same portions are represented by the same reference numerals.

### Configuration

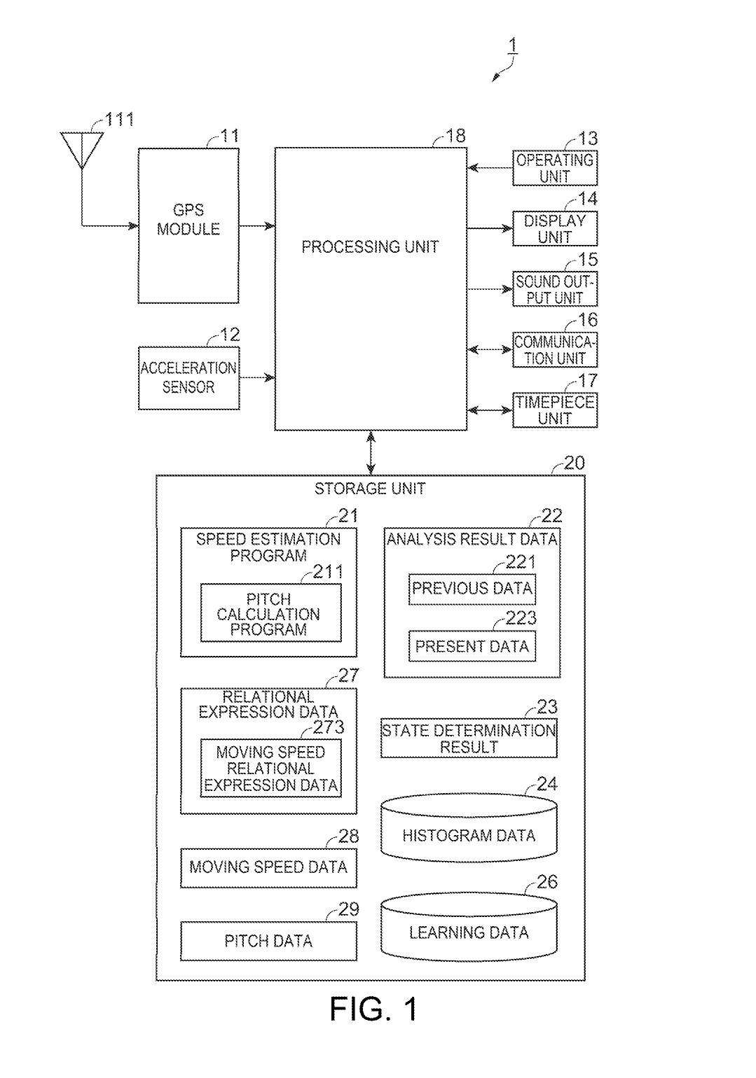

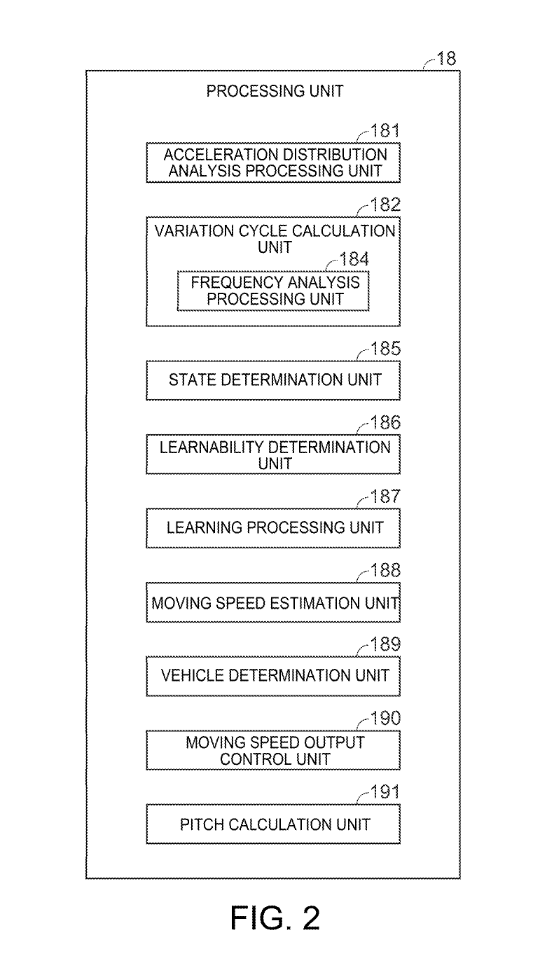

FIG. 1 is a block diagram showing a primary functional configuration example of a running watch 1. FIG. 2 is a block diagram showing a functional configuration example of a processing unit 18 constituting the running watch 1. As shown in FIG. 1, the running watch 1 includes a GPS module 11, an acceleration sensor 12, an operating unit 13, a display unit 14, a sound output unit 15, a communication unit 16, a timepiece unit 17, a processing unit 18, and a storage unit 20.

The GPS module 11 receives a GPS satellite signal transmitted from a GPS satellite as a positioning satellite through a GPS antenna 111, measures the position and moving speed of the user based on the received GPS satellite signal, and outputs the position and moving speed to the processing unit 18 arbitrarily. Hereinafter, the moving speed measured by the GPS module 11 is referred to as “GPS moving speed”. A method of measuring the position or moving speed using the GPS is known in the related art, and thus detailed description thereof will be omitted.

The acceleration sensor 12 detects an acceleration vector of the user. As the acceleration sensor 12, for example, a micro electro mechanical systems (MEMS) sensor is used. The acceleration vector detected by the acceleration sensor 12 is output to the processing unit 18 as a detected acceleration.

The operating unit 13 is realized by various switches, such as a button switch, a lever switch, and a dial switch, or an input device, such as a touch panel, and outputs an operation signal according to an operation input to the processing unit 18.

The display unit 14 is realized by a display device, such as a liquid crystal display (LCD) or an electroluminescence (EL) display, and displays various screens based on a display signal input from the processing unit 18.

The sound output unit 15 is realized by a sound output device, such as a speaker, and outputs various kinds of sound based on a sound signal input from the processing unit 18.

The communication unit 16 is a communication device which performs transmission and reception of information for use inside the apparatus with respect to an external information processing apparatus under the control of the processing unit 18. As a communication method of the communication unit 16, various methods, such as a form in which wired connection is established through a cable based on a predetermined communication standard, a form in which connection is established through an intermediate device, called a cradle and serving also as a charger, and a form in which wireless connection is established using wireless communication, may be applied. For example, the positional information or speed information of the user, the distance information, or the like measured by the running watch 1 is transmitted to a personal computer (PC) through the communication unit 16, and the PC appropriately performs reading or data management.

The timepiece unit 17 is an internal timepiece of the running watch 1, and is constituted by a quartz oscillator having a quartz vibrator and an oscillation circuit, or the like. The measured time of the timepiece unit 17 is output to the processing unit 18 arbitrarily.

The processing unit 18 is realized by a control device and an arithmetic device, for example, a microprocessor, such as a central processing unit (CPU) or a digital signal processor (DSP), or an application specific integrated circuit (ASIC), and performs overall control of the respective units of the running watch 1. The processing unit 18 functions as an exercise amounts calculation unit which calculates exercise amounts. As shown in FIG. 2, the processing unit 18 includes an acceleration distribution analysis processing unit 181 as a determination unit, a variation cycle calculation unit 182, a state determination unit 185, a learnability determination unit 186, a learning processing unit 187 as a derivation unit, a moving speed estimation unit 188 as a speed estimation unit, a vehicle determination unit 189, a moving speed output control unit 190, and a pitch calculation unit 191. The respective units constituting the processing unit 18 may be constituted by hardware, such as a dedicated module circuit.

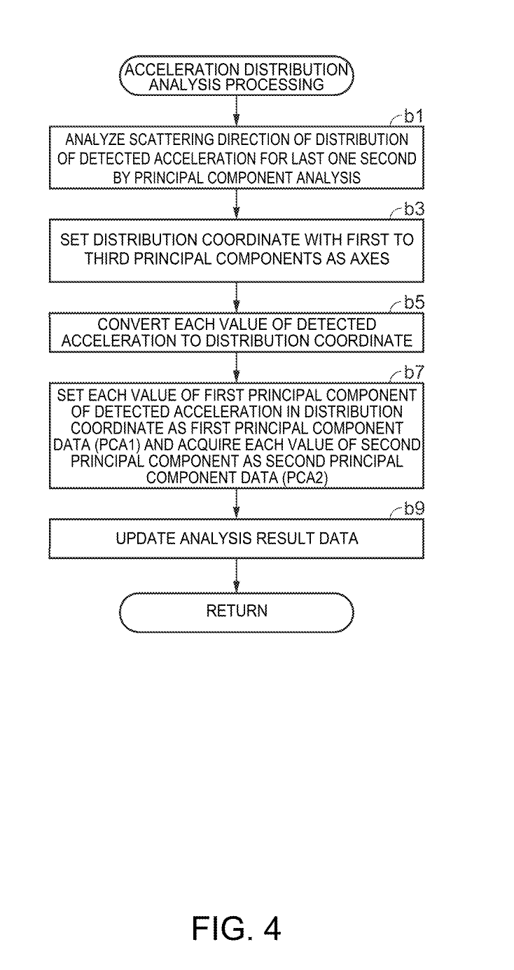

The acceleration distribution analysis processing unit 181 performs acceleration distribution analysis processing described below (see FIG. 4), and acquires first principal component data (hereinafter, referred to as “PCA1”) and second principal component data (hereinafter, referred to as “PCA2”) based on the detected acceleration, an eigenvector, and the like. For example, one of the first principal component data (PCA1) and the second principal component data (PCA2), which are the principal component analysis result of the detected acceleration, corresponds to an up-and-down motion direction component of the body of the user, and the other principal component data corresponds to an arm swinging direction component.

The variation cycle calculation unit 182 performs processing for obtaining, for example, a frequency as a variation cycle of a step operation corresponding to a pitch which is the number of steps of the user per unit time. In this embodiment, there are several types of “frequency” as the variation cycle depending on the difference in the calculation method, and for example, a method which calculates the frequency using frequency analysis, such as FFT or autocorrelation, is known. A method which calculates the frequency using maximum likelihood estimation is used, whereby it is possible to calculate the frequency with higher precision.

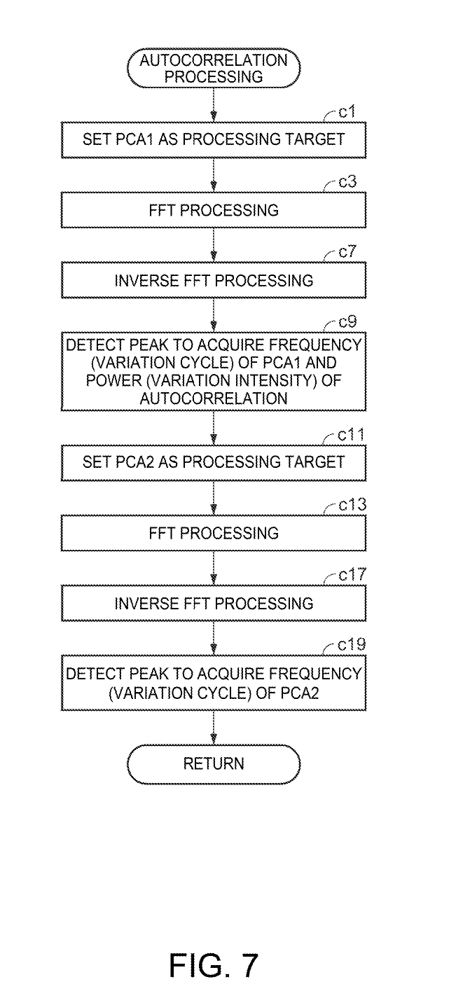

The variation cycle calculation unit 182 includes a frequency analysis processing unit 184. The frequency analysis processing unit 184 performs, for example, autocorrelation processing described below as frequency analysis processing (see FIG. 7), and acquires the frequency (first variation cycle) and power (first variation intensity) of PCA1, the frequency (second variation cycle) and power (second variation intensity) of PCA2, and the FFT maximum power (second variation intensity) of PCA2 based on the first principal component data (PCA1) and the second principal component data (PCA2). The acquired values will be described below in detail.

The pitch calculation unit 191 calculates pitch information (the number of steps per unit time) based on the frequency which is the variation cycle calculated by the variation cycle calculation unit 182, in particular, the frequency of the step operation of the user. For example, if the unit time is one minute, the frequency of the step operation is converted into a frequency per minute and set as pitch information. The pitch information may be calculated from a frequency obtained by carrying out any filter processing (for example, LPF processing) on the frequency of the up-and-down body motion calculated by the variation cycle calculation unit 182.

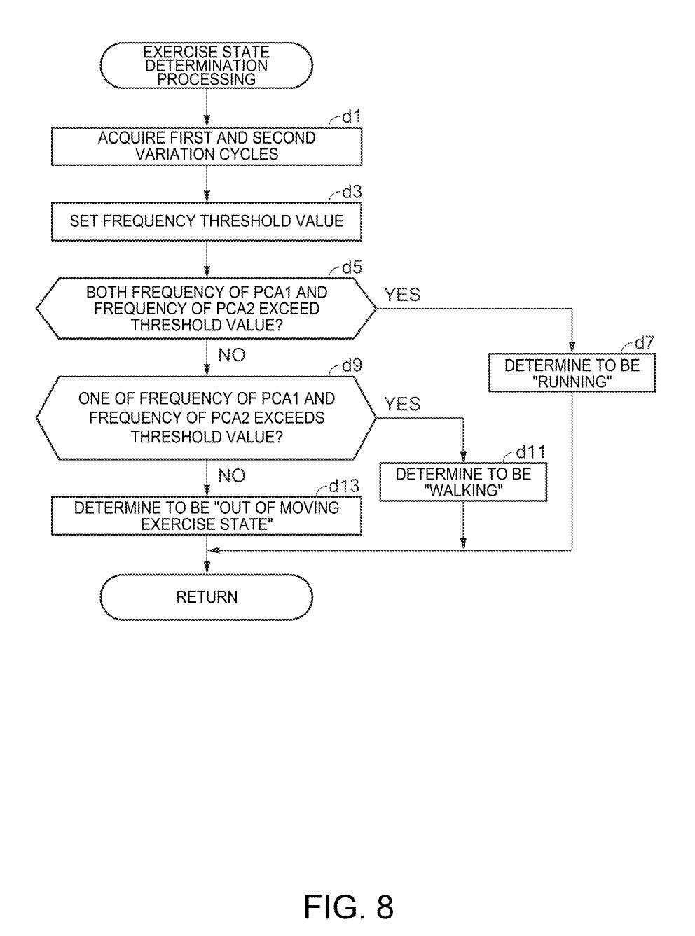

The state determination unit 185 performs state determination processing described below (see FIG. 8), and determines the state of the user to be “running”, “walking”, or “out of moving exercise state” based on the values of the frequency (first frequency) of PCA1 and the frequency (second frequency) of PCA2 with respect to a frequency threshold value set in advance.

The learnability determination unit 186 performs learnability determination processing described below and determines the learnability based on the signal intensity of the GPS satellite signal and the state of the user.

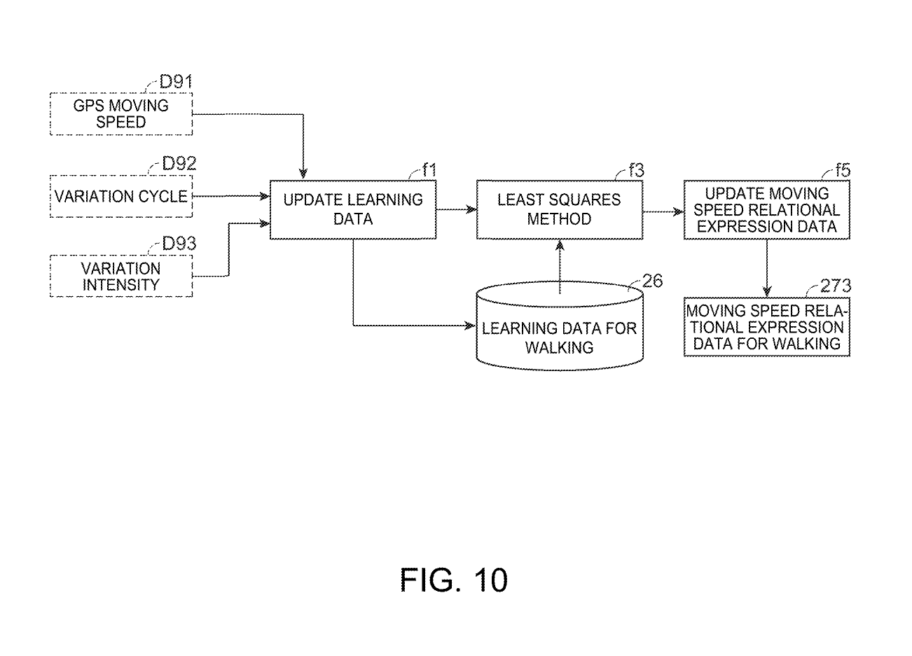

When the learnability determination unit 186 determines that the state of the user is learnable, the learning processing unit 187 performs learning processing (see FIG. 10). Specifically, the learning processing unit 187 derives a moving speed relational expression for running or walking according to the state of the user based on the GPS moving speed, the frequency (variation cycle) of at least one of the first principal component direction and the second principal component direction, and at least one variation intensity of the first variation intensity and the second variation intensity.

The moving speed estimation unit 188 calculates the moving speed of the user as “estimated moving speed” using the moving speed relational expression for running when the state of the user is “running” and the moving speed relational expression for walking when the state of the user is “walking”.

The vehicle determination unit 189 performs vehicle determination processing described below and performs determination of whether or not the user is in a vehicle, such as an automobile or a train, based on the GPS moving speed or the frequency (variation cycle) of at least one of the first principal component direction and the second principal component direction of the user.

The moving speed output control unit 190 outputs the estimated moving speed as the moving speed of the user if the user is not in the vehicle and outputs the GPS moving speed as the moving speed of the user if the user is in the vehicle.

The storage unit 20 is realized by a storage medium, such as various integrated circuit (IC) memories including a read only memory (ROM), a flash ROM, and a random access memory (RAM), or a hard disk. The storage unit 20 stores a program which operates the running watch 1 and realizes various functions of the running watch 1, and data for use during the execution of the program, and the like in advance, or temporarily stores data each time processing is performed.

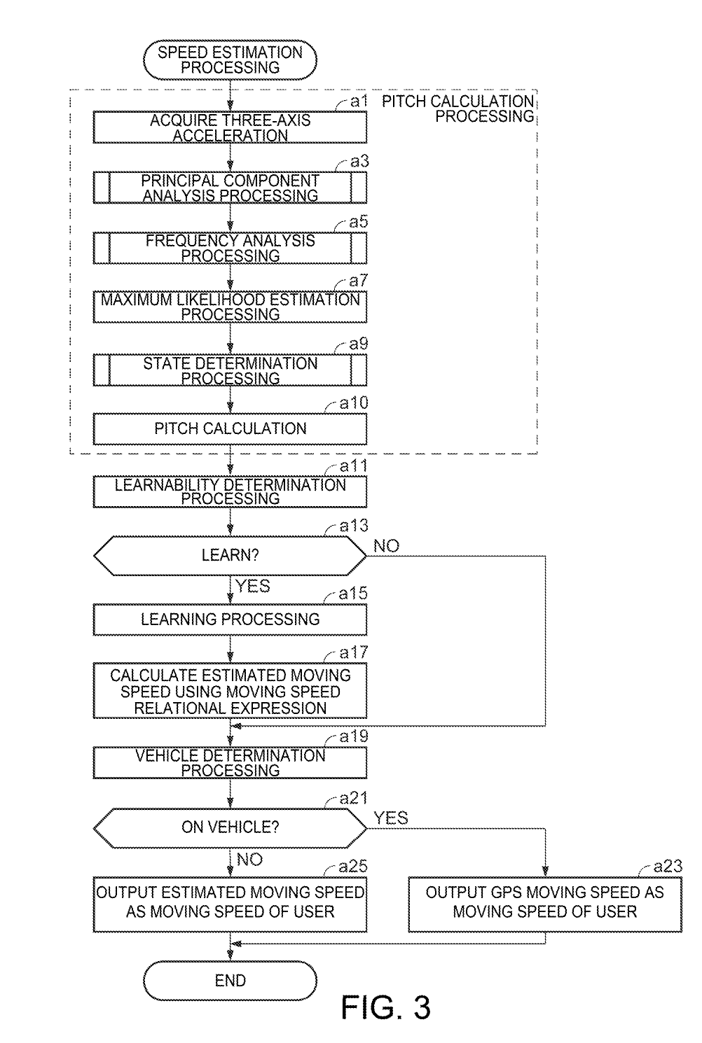

The storage unit 20 stores a speed estimation program 21 which causes the processing unit 18 to function as the acceleration distribution analysis processing unit 181, the variation cycle calculation unit 182, the state determination unit 185, the learnability determination unit 186, the learning processing unit 187, the moving speed estimation unit 188, the vehicle determination unit 189, the moving speed output control unit 190, and the pitch calculation unit 191, and performs speed estimation processing (see FIG. 3). The speed estimation program 21 includes, as a subroutine program, a pitch calculation program 211 relating to pitch calculation processing.

The storage unit 20 stores analysis result data 22, a state determination result 23, histogram data 24, learning data 26, relational expression data 27, moving speed data 28, and pitch data 29.

The analysis result data 22 includes previous data 221 and present data 223. As described below, the speed estimation processing is repeatedly performed every second. The previous data 221 stores the first principal component data (PCA1), the second principal component data (PCA2), the eigenvector, and the like acquired by the acceleration distribution analysis processing unit 181 the previous time (in the preceding one second). Then, the present data 223 stores the first principal component data (PCA1), the second principal component data (PCA2), the eigenvector, and the like acquired by the acceleration distribution analysis processing unit 181 this time.

The state determination result 23 stores the state (“running”, “walking”, or “out of moving exercise state”) of the user determined by the state determination unit 185 this time.

The histogram data 24 stores the histogram of the frequency (first variation cycle) of PCA1 and the frequency (second variation cycle) of PCA2 collected in the course of the repetitive speed estimation processing.

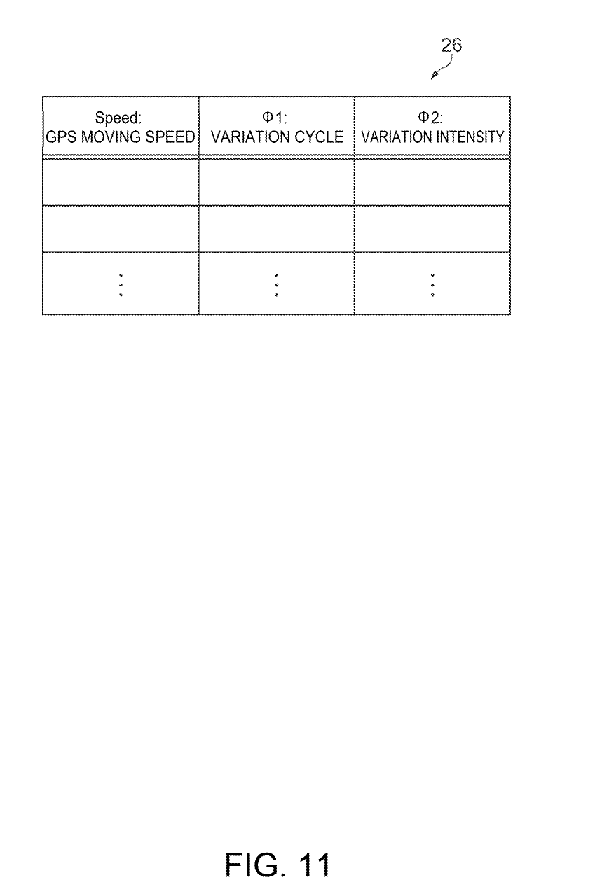

The learning data 26 is collected in the course of the repetitive speed estimation processing. Then, the learning data 26 is referred to when the learning processing unit 187 learns and updates a moving speed relational expression. A specific data configuration of the learning data 26 will be described below (see FIG. 11).

The relational expression data 27 stores the latest moving speed relational expression data 273 derived by the learning processing unit 187.

The moving speed data 28 stores the moving speed (estimated moving speed or GPS moving speed) of the user output from the moving speed output control unit 190 for each speed estimation processing in time series.

The pitch data 29 stores the pitch information calculated by the pitch calculation unit 191 in time series.

### Flow of Processing

FIG. 3 is a flowchart showing a processing procedure of the speed estimation processing. The processing described herein can be realized by the processing unit 18 reading the speed estimation program 21 from the storage unit 20 and executing the speed estimation program 21. The running watch 1 performs processing according to the processing procedure of FIG. 3 to carry out a speed estimation method.

The speed estimation processing shown in FIG. 3, for example, starts if the user performs a measurement start operation through the operating unit 13, and the processing of Steps a1 to a25 is repeatedly executed every second until a measurement end operation is performed. If the measurement start operation is performed, the measurement of the GPS moving speed or the like by the GPS module 11, the detection of the detected acceleration by the acceleration sensor 12, and the like start, and are executed in parallel until the speed estimation processing ends. A detection result signal is output from the acceleration sensor 12 arbitrarily, and the processing unit 18 samples and loads the detection result signal at a predetermined sampling rate as a detected acceleration and uses the sampling result in the speed estimation processing. Although the sampling rate can be, for example, 32 samples per second, of course, a different sampling rate may be used.

In the speed estimation processing, first, the acceleration in each axis direction of the three axes (x, y, z) is acquired by the acceleration sensor 12 (Step a1).

Subsequently, the acceleration distribution analysis processing unit 181 performs acceleration distribution analysis processing. Specifically, the distribution of the detected acceleration in a coordinate (sensor coordinate) space corresponding to the respective axis directions (x, y, z) of the acceleration sensor 12 is analyzed, and principal component analysis for extracting the direction of the distribution of a primary component (principal component) is performed (Step a3). For example, in regard to the direction of the principal component, when focusing on the top two principal components, a maximum scattering direction having the largest spread of the distribution can be extracted as a first principal component, and a scattering direction having the second largest spread of the distribution crossing (for example, orthogonal to) the first principal component can be extracted as a second principal component. In this way, the first principal component data (PCA1) and the second principal component data (PCA2) which are principal component data of the respective scattering directions are obtained. Instead of the principal component analysis, acceleration distribution analysis processing may be performed using independent component analysis which is a calculation method for separating into a plurality of additive components.

FIG. 4 is a flowchart showing a detailed processing procedure of the acceleration distribution analysis processing. As shown in FIG. 4, in the acceleration distribution analysis processing, the acceleration distribution analysis processing unit 181 analyzes the scattering direction of the distribution of the detected acceleration for 32 samples of the previous one second by principal component analysis (Step b1). Although the details of the principal component analysis are known in the related art and description thereof will be omitted, in this embodiment, a direction perpendicular to the first principal component and the second principal component shown in FIG. 4 is extracted as a third principal component (a component other than the up-and-down motion direction component and the arm swinging direction component) to extract three principal components, and the eigenvalues and eigenvectors of the respective principal components are calculated.

Then, the acceleration distribution analysis processing unit 181 sets a distribution coordinate with the direction of the first principal component as a first coordinate axis, the direction of the second principal component as a second coordinate axis, and the direction of the third principal component as a third coordinate axis by the principal component analysis (Step b3), converts each value of the detected acceleration to the distribution coordinate (Step b5), and acquires each value of the first coordinate axis of the detected acceleration in the distribution coordinate as first principal component data (PCA1) and each value of the second coordinate axis as the second principal component data (PCA2) (Step b7).

Thereafter, as processing of Step b9, the acceleration distribution analysis processing unit 181 updates the analysis result data 22 with data including at least the first principal component data (PCA1), the second principal component data (PCA2), and the eigenvector as the present data 223. In the second or subsequent speed estimation processing, the acceleration distribution analysis processing unit 181 updates the analysis result data 22 with the present data 223 before update as the previous data 221.

According to the acceleration distribution analysis processing described above, it is possible to separate and extract the up-and-down motion direction component and the arm swinging direction component of the body from the detected acceleration. With this, after an exceptional component (third principal component) not correlated with the method to run, walk, swing an arm, or the like included in the value of the detected acceleration is excluded, the principal components can be used in subsequent processing. In this way, in the subsequent processing, it is not necessary to be conscious of the respective axis directions (x, y, z) of the acceleration sensor 12. With this, the calculation of the estimated moving speed can be performed without being influenced by a mounting state, such as the mounting direction of the running watch 1.

Returning to FIG. 3, if the acceleration distribution analysis processing (principal component analysis processing) of Step a3 ends, subsequently, the frequency analysis processing unit 184 performs frequency analysis processing (Step a5). This processing uses the first principal component data (PCA1) and the second principal component data (PCA2) for the last two seconds stored in the analysis result data 22 as the previous data 221 and the present data 223.

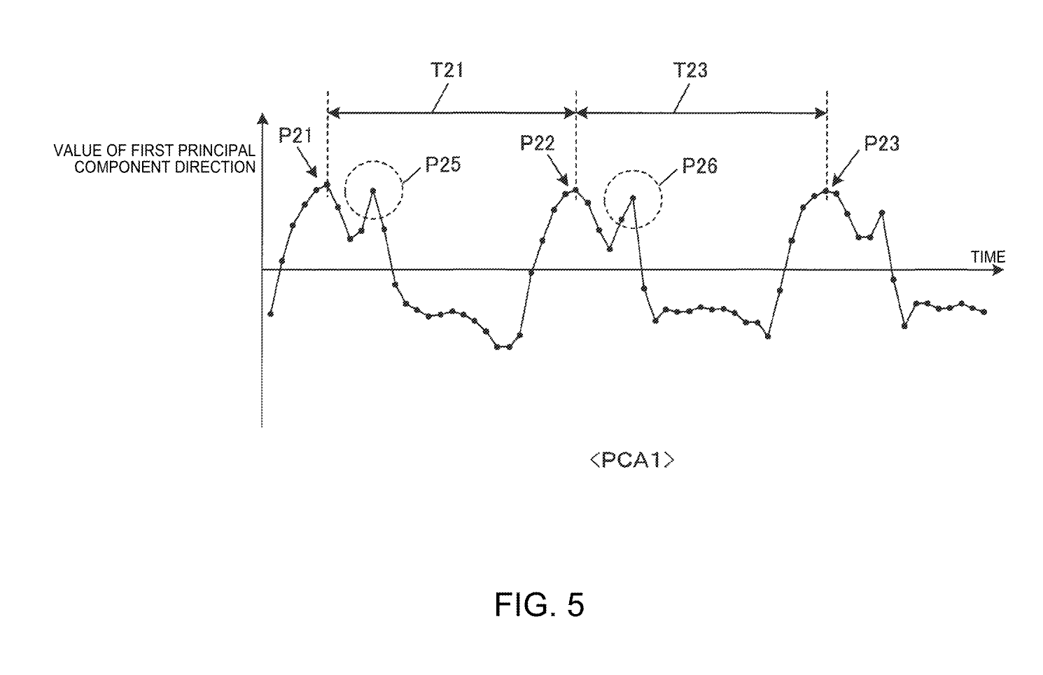

FIG. 5 is a diagram showing the first principal component data (PCA1) for the last two seconds. As described above, the first principal component data (PCA1) and the second principal component data (PCA2) periodically change in the variation cycles of the operation of the first principal component direction and the operation of the second principal component direction. Accordingly, for example, when focusing on the first principal component data (PCA1) of FIG. 5, peaks P21, P22, and P23 of a periodically varying waveform are detected, and the frequency of the first principal component data (PCA1) can be found from the average value of the times T21 and T23 among the peaks P21, P22, and P23, or the like. However, in an actual periodically varying waveform, peaks P25 and P26 surrounded by a broken line in FIG. 5 other than the peaks P21, P22, and P23 of periodic variation appear, causing erroneous detection.

In order to reduce the erroneous detection, although a method which extends the time length of the first principal component data (PCA1) or the second principal component data (PCA2) for peak detection is considered, followability to change over time of the pitch or the like is damaged, and it is not possible to specify power of the first principal component direction or the second principal component direction from the periodically varying waveform itself of the first principal component data (PCA1) or the like. Accordingly, the frequency analysis processing unit 184 performs the frequency analysis processing to acquire the frequency and power from the first principal component data (PCA1) and the second principal component data (PCA2) for the last two seconds. The frequency analysis processing may be performed using, for example, autocorrelation processing.

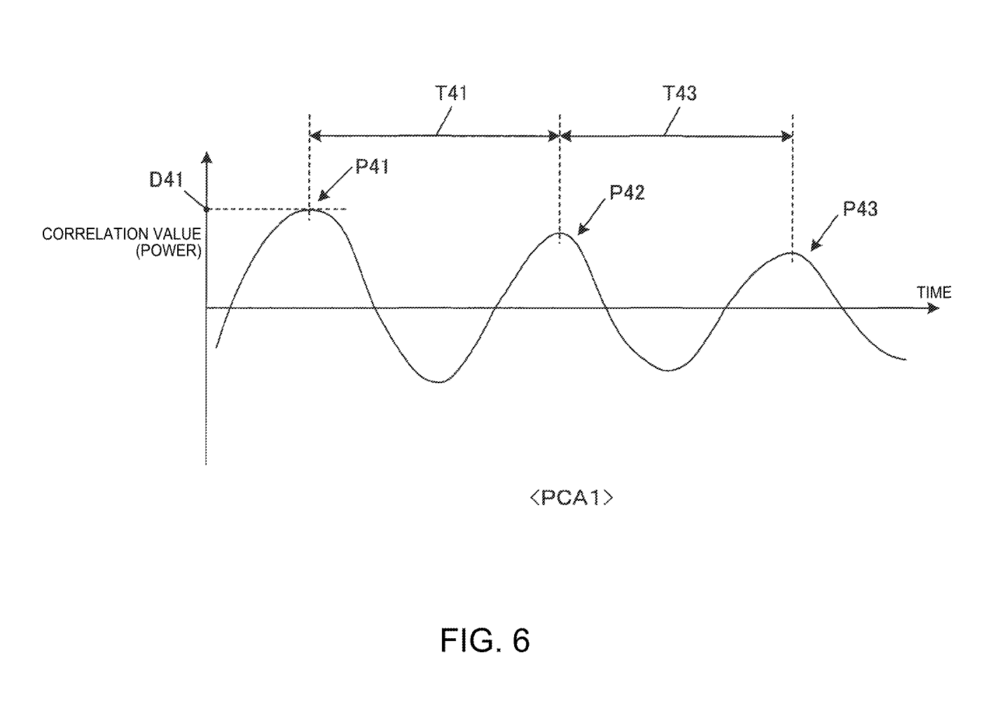

FIG. 6 is a diagram showing the processing result of autocorrelation processing as the frequency analysis processing of the first principal component data (PCA1) of FIG. 5. As shown in FIG. 6, if the autocorrelation processing is performed, it is possible to obtain the entire shape of a periodically varying waveform in which only the periodicity of the first principal component data (PCA1) appears as the peak. Accordingly, peak detection is performed for the autocorrelation processing result, whereby it is possible to calculate the frequency (first variation cycle) of PCA1 from the times T41 and T43 among peaks P41, P42, and P43. The frequency analysis processing unit 184 also acquires the maximum value (in FIG. 6, a correlation value D41 of the peak P41) of a correlation value as power (first variation intensity) of autocorrelation from the autocorrelation processing result of the first principal component data (PCA1). Similarly, the frequency analysis processing unit 184 performs peak detection for the autocorrelation processing result of the second principal component data (PCA2) and calculates the frequency (second variation cycle) and power (second variation intensity) of PCA2.

The autocorrelation processing can be replaced with processing using predetermined frequency analysis and predetermined inverse frequency analysis, for example, processing using FFT (Fast Fourier Transform) processing and inverse FFT processing. It is possible to acquire the power (FFT maximum power of PCA1) of the up-and-down motion direction and the power (FFT maximum power of PCA2) of the arm swinging direction from the FFT processing result. The FFT processing and the inverse FFT processing are used, whereby it is possible to reduce the amount of calculation and to achieve high-speed processing. FIG. 7 is a flowchart showing a detailed processing procedure of the autocorrelation processing as the frequency analysis processing.

As shown in FIG. 7, in the autocorrelation processing, the frequency analysis processing unit (in this case, autocorrelation processing unit) 184 first reads the first principal component data (PCA1) from the previous data 221 and the present data 223 referring to the analysis result data 22 and sets the first principal component data (PCA1) for the last two seconds as a processing target (Step c1).

Subsequently, the frequency analysis processing unit (autocorrelation processing unit) 184 performs FFT processing for the first principal component data (PCA1) for the last two seconds set as a processing target (Step c3).

Subsequently, the frequency analysis processing unit (autocorrelation processing unit) 184 performs inverse FFT processing for the FFT processing result of Step c3 (Step c7). Then, the frequency analysis processing unit (autocorrelation processing unit) 184 performs peak detection for the inverse FFT processing result and acquires the frequency (first variation cycle) of PCA1 and the power (first variation intensity) of autocorrelation (Step c9).

Thereafter, the frequency analysis processing unit (autocorrelation processing unit) 184 reads the second principal component data (PCA2) from the previous data 221 and the present data 223 referring to the analysis result data 22 and sets the second principal component data (PCA2) for the last two seconds as a processing target (Step c11). Then, similarly to Steps c3 to c7, the frequency analysis processing unit (autocorrelation processing unit) 184 performs FFT processing for the second principal component data (PCA2) for the last two seconds set as a processing target (Step c13) and performs inverse FFT processing for the FFT processing result of Step c13 (Step c17). Then, the frequency analysis processing unit (autocorrelation processing unit) 184 performs peak detection for the inverse FFT processing result and acquires the frequency (variation cycle) of PCA2 (Step c19).

Prior to the inverse FFT processing of Steps c7 and c17, a frequency out of a frequency region assumed to be the first principal component direction component or the second principal component direction component may be cut, whereby it is possible to improve the precision of the autocorrelation processing.

According to the frequency analysis processing (autocorrelation processing) described above, it is possible to acquire the frequency (first variation cycle) of PCA1 and the frequency (second variation cycle) of PCA2 without erroneous calculation. As a result, the improvement of calculation precision of the estimated moving speed described below is achieved. The correlation value can be acquired as the power (first and second variation intensities) of PCA1 and PCA2.

Returning to FIG. 3, if the frequency analysis processing of Step a5 ends, subsequently, a maximum likelihood estimation method is used, whereby it is possible to calculate a more accurate variation cycle (Step a7).

Subsequently, the state determination unit 185 performs state determination processing for determining the exercise state of the user (Step a9). In the state determination processing, the state determination unit 185 performs determination of whether the state of the user is “running” or “walking” which is a moving exercise state, or “out of moving exercise state”.

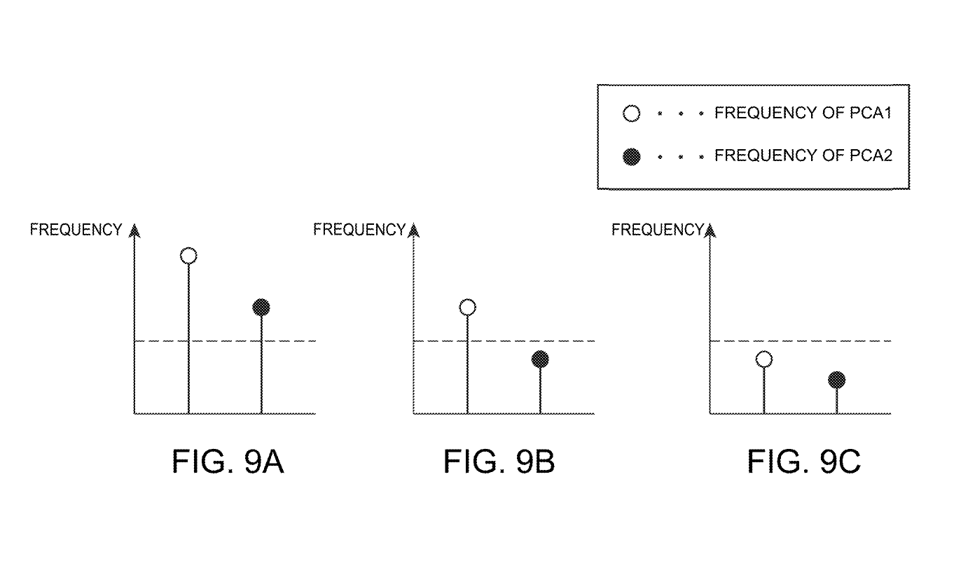

A determination principle of whether the state of the user is “running” or “walking” will be described referring to FIGS. 9A to 9C. FIGS. 9A to 9C are explanatory views showing three typical states of the user in state determination processing. FIGS. 9A to 9C show the values of the frequency (white circle) of PCA1 in the first variation cycle and the frequency (black circle) of PCA2 in the second variation cycle with respect to the threshold value (broken line) of the frequency set in advance for determining the state of the user with the vertical axis representing frequency. Hereinafter, a specific example will be described.

First, FIG. 9A shows a typical example of the frequency (white circle) of PCA1 and the frequency (black circle) of PCA2 during running. That is, as shown in FIG. 9A, when both the frequency of PCA1 and the frequency of PCA2 exceed the threshold value, it is possible to determine that the state of the user is “running”

FIG. 9B shows a typical example of the frequency (white circle) of PCA1 and the frequency (black circle) of PCA2 during walking. That is, as shown in FIG. 9B, when one of the frequency of PCA1 and the frequency of PCA2 exceeds the threshold value and the other frequency falls below the threshold value, it is possible to determine that the state of the user is “walking”

FIG. 9C shows the frequency (white circle) of PCA1 and the frequency (black circle) of PCA2 in a state of “out of moving exercise state”, instead of “running” or “walking” That is, unlike the value of each frequency to the threshold value shown in FIGS. 9A and 9B, when both the frequency of PCA1 and the frequency of PCA2 have a value not reaching the threshold value, it is possible to determine that the state of the user is “out of moving exercise state”, instead of “running” or “walking”

The illustrated moving exercise state condition and state determination condition are based on the typical example shown in FIGS. 9A to 9C. Accordingly, optimum moving exercise state condition and state determination condition on which data is collected and analyzed from various users to absorb an individual difference may be appropriately set.

On the other hand, the user may view the display of the running watch 1 during running or walking, or may perform an operation (abnormal operation) to wipe the sweat not occurring during the normal arm swinging operation, and in this case, the direction of the principal component of the detected acceleration, that is, the scattering direction is displaced. In learning processing described below, after a characteristic value is collected in the course of the speed estimation processing, the moving speed relational expression for estimating the moving speed of the user is updated. For this reason, if a characteristic value obtained when the abnormal operation is performed is used in the learning processing, there is a problem in that the calculation precision of the estimated moving speed is degraded. Even when the user temporarily stops running or walking, or completely stops running or walking, the same problem occurs.

Accordingly, the state determination unit 185 first performs determination of whether or not an abnormal operation as the state of the user is performed. The abnormal operation may be determined by an eigenvector inner product (inner product value) of a present eigenvector and a previous eigenvector, or when it is confirmed that the relationship between the frequency (second variation cycle) of PCA2 and the frequency (first variation cycle) of PCA1 is largely deviated with large change of the eigenvector inner product, this may be used to determine “abnormal operation”.

FIG. 8 is a flowchart showing a detailed processing procedure of the state determination processing.

As shown in FIG. 8, in the state determination processing, the state determination unit 185 first acquires the first variation cycle and the second variation cycle from the variation cycle calculation unit 182 (Step d1).

Next, the state determination unit 185 sets a threshold value (for example, 1.5 Hz) of a predetermined frequency to be applied to the frequency of the first variation cycle (the frequency of PCA1) and the frequency of the second variation cycle (the frequency of PCA2) for state determination in the acquired first variation cycle and second variation cycle (Step d3).

Subsequently, the state determination unit 185 determines the state of the user based on the values of the frequency of PCA1 and the frequency of PCA2 to the threshold value of the frequency set in Step d3. For example, as shown in FIG. 9A, when both the frequency of PCA1 and the frequency of PCA2 exceed the threshold value (Step d5: Yes), it is determined that the state of the user is “running” (Step d7), and the state determination result 23 is updated to “running”

In Step d5, when both the frequency of PCA1 and the frequency of PCA2 are in a state different from the state of exceeding the threshold value (Step d5: No), the state determination unit 185 progresses to subsequent Step d9.

Subsequently, as shown in FIG. 9B, when one of the frequency of PCA1 and the frequency of PCA2 exceeds the threshold value and the other frequency falls below the threshold value (Step d9: Yes), the state determination unit 185 determines that the state of the user is “walking” (Step d11), and updates the state determination result to “walking”

In Step d9 of FIG. 8, as shown in FIG. 9C, when only one of the first frequency and the second frequency is in a state different from the state of exceeding the threshold value (Step d9: No), it is determined that the state of the user is “out of moving exercise state”, instead of “running” or “walking”, and the state determination result 23 is set as “out of moving exercise state” (Step d13), thereby updating the state determination result.

Returning to FIG. 3, if the state determination processing of Step a9 ends, subsequently, pitch calculation is performed (Step a10). Specifically, the pitch calculation unit 191 calculates pitch information using the frequency (variation cycle) of the step operation (up-and-down body motion) derived by maximum likelihood estimation. It is possible to calculate the pitch information by converting the frequency of the step operation (up-and-down body motion) into the number of steps per minute. The calculated pitch information is stored in the pitch data 29 of the storage unit 20. The pitch information may be displayed and output.

When separating the pitch calculation processing from the speed estimation processing and calculating and outputting only the pitch information, Steps a1 to al0 can be called the pitch calculation processing.

Subsequently, the learnability determination unit 186 performs learnability determination processing (Step a11). For example, the learnability determination unit 186 performs threshold processing for the signal intensity of the GPS satellite signal received by the GPS antenna 111 in the GPS module 11 and when the signal intensity is equal to or less than a predetermined threshold value, the learnability determination unit 186 determines that learning is not performed. In the latter learning processing, the GPS moving speed is used to learn or update the moving speed relational expression for walking or running corresponding to the state of the user determined in the above-described state determination processing. Meanwhile, when the signal intensity of the GPS satellite signal is weak, the reliability of the GPS satellite signal is degraded, and thus it is assumed that learning is not performed. This processing can be realized by setting a predetermined threshold value as a low reliability condition as an index value representing the reliability of the signal intensity of the GPS satellite signal. In addition, in the learnability determination processing, the learnability determination unit 186 determines that learning is not performed when “out of moving exercise state” is set as the state of the user referring to the state determination result 23.

When the reliability of the GPS satellite signal does not satisfy the low reliability condition or when the state of the user set in the state determination result 23 is not “out of moving exercise state”, the learnability determination unit 186 determines that learning is performed.

When learning is not performed, this means that the update of the learning data 26 in the latter learning processing is not performed. According to the above-described learnability determination processing, it is possible to inhibit the update of the learning data 26 when the reliability of the GPS satellite signal satisfies the low reliability condition or when the user is not in the moving exercise state, and to inhibit the use of the learning data 26 to learn or update the moving speed relational expression using the learning data 26. With this, it is possible to reduce a situation in which the calculation precision of the estimated moving speed is degraded.

Then, as a result of the learnability determination processing of Step a11, when it is determined that learning is performed (Step a13: Yes), the learning processing unit 187 performs learning processing (Step a15) and thereafter, progresses to Step a17. When it is determined that learning is not performed (Step a13: No), the learning processing of Step a15 is not performed and the process progresses to Step a19. FIG. 10 is a diagram illustrating a processing procedure of the learning processing.

As shown in FIG. 10, in the learning processing, the learning processing unit 187 first adds a GPS moving speed D91, a variation cycle (at least one of the first variation cycle and the second variation cycle) D92, and a variation intensity (at least one of the first variation intensity and the second variation intensity) D93 to the learning data 26 for walking to update the learning data 26 for walking (f1). When it is determined to be “running” by the above-described state determination processing, the variation cycle and the variation intensity are added to the learning data for running to update the learning data for running

FIG. 11 is a diagram showing a data configuration example of the learning data 26 as results data. As shown in FIG. 11, the learning data 26 is a data table in which Speed: GPS moving speed, φ1: variation cycle, and φ2: variation intensity are associated with one another. With this processing, in the learning data 26, the variation cycle and the variation intensity acquired when the state of the user is “walking” or “running” are associated with the GPS moving speed, and as described above, the learning data for running and the learning data for walking are separately accumulated.

Returning to FIG. 10, subsequently, the learning processing unit 187 uses the learning data 26 and applies a known least squares method to derive a moving speed relational expression expressed by Expression (1) by learning (f3). In Expression (1), wⱼ represents a probability variable. In the least squares method, the GPS moving speed is used as Speed, and the probability variable wⱼ is statistically determined based on a predetermined characteristic value φJ.

$$speed = {\sum }_{j = 1}^{M - 1} {w}_{j} \cdot {φ}_{j} ( x ) \qquad ( 1 )$$

Here, the variation cycle corresponding to the number of steps (pitch) of the user per unit time is highly correlated with the moving speed of the user. It is also considered that the intensity (variation intensity) of the variation cycle is correlated with the moving speed of the user. Accordingly, in this embodiment, in FIG. 11, the variation cycle and the variation intensity represented as φ1 and φ2 are used as a characteristic value.

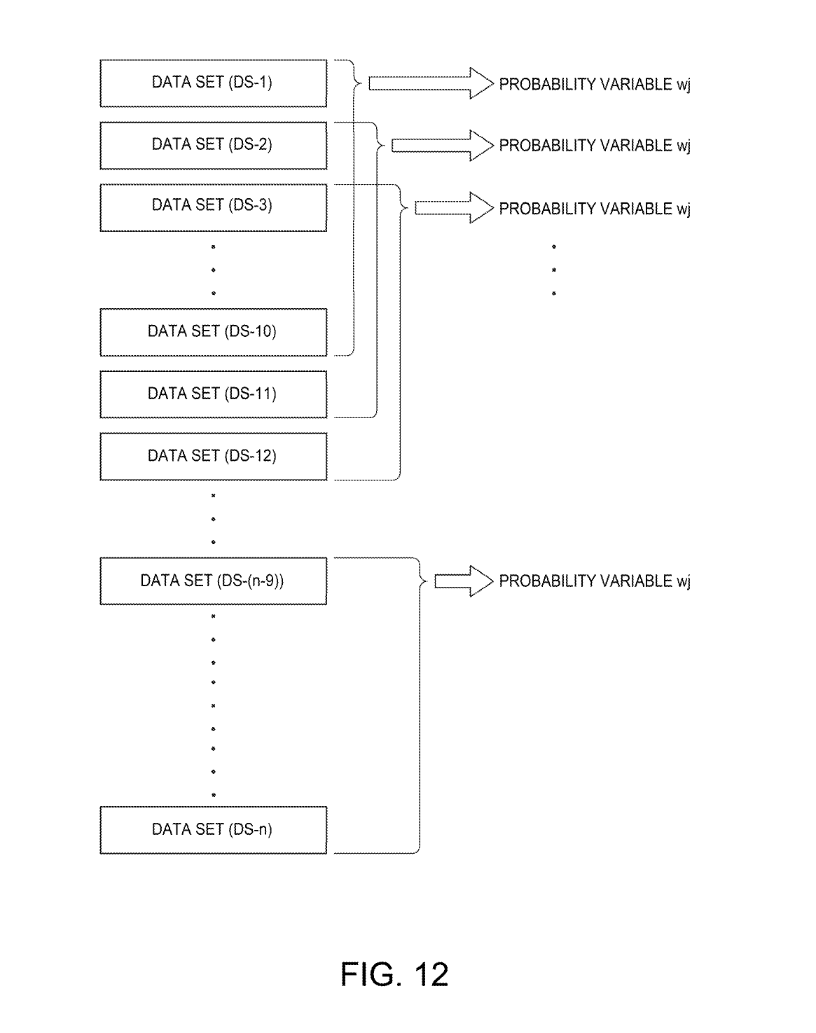

FIG. 12 is a diagram illustrating the least squares method. As shown in FIG. 11, in the learning data 26, data sets in which the GPS moving speed, the variation cycle, and the variation intensity are associated with one another are accumulated arbitrarily to be data sets DS-1, DS-2, DS-3, . . . as shown in FIG. 12. Here, when the tenth data set DS-10 is added to the learning data 26, the learning processing unit 187 performs the least squares method using the ten data sets DS-1 to DS-10 including the added data set DS-10 to newly determine the probability variable wⱼ. When the lowermost data set DS-n is added to the learning data (for walking) 26, the learning processing unit 187 performs the least squares method using all data sets DS-(n−9) to DS-n including the added data set DS-n to newly determine the probability variable wⱼ. Accordingly, it is possible to realize the derivation of a moving speed relational expression for walking in which the present data set is reflected.

In the derivation of the moving speed relational expression, a sequential statistical method other than the above-described least squares method may be used.

Thereafter, the learning processing unit 187 sets the newly determined probability variable wⱼ with the moving speed relational expression derived by the least squares method using the learning data 26 as the moving speed relational expression for walking to update the moving speed relational expression data 273 (f5).

According to the above-described learning processing, it is possible to derive the moving speed relational expression for walking or running using the characteristic value, such as the variation cycle or variation intensity correlated with the moving speed of the user. When deriving the moving speed relational expression for walking or running, the GPS moving speed can be used. The GPS moving speed is the value when it is determined that the reliability of the GPS satellite signal does not satisfy the low reliability condition in the former learnability determination processing.

Returning to FIG. 3, thereafter, in Step a17, the moving speed estimation unit 188 reads the moving speed relational expression data 273 from the storage unit 20 and uses the moving speed relational expression data 273 to calculate an estimated moving speed. Specifically, the moving speed estimation unit 188 substitutes the probability variable wⱼ stored as the moving speed relational expression data 273, the variation cycle φ1 and the variation intensity φ2 acquired in the present speed estimation processing in Expression (2), and sets the found Speed as the estimated moving speed.

$$speed = {\sum }_{j = 1}^{M - 1} {w}_{j} \cdot {φ}_{j} \qquad ( 2 )$$

As described above, after the estimated moving speed is calculated, subsequently, the vehicle determination unit 189 performs vehicle determination processing (Step a19). For example, when the value of the frequency of the variation cycle corresponding to the number of steps (pitch) of the user per unit time is sufficiently small and the user is in a non-exercise state other than the moving exercise state of “running” or “walking”, and when the GPS moving speed is sufficiently fast, the vehicle determination unit 189 determines that the user is in a vehicle, such as a bicycle, a motorcycle, an automobile, or a train. The threshold value of the frequency of at least one of the first variation cycle and the second variation cycle for the determination of whether or not the user is in the non-exercise state and the threshold value for the determination of the GPS moving speed may be set in advance.

As another example, even though the frequency of the variation cycle is equal to or greater than a predetermined threshold value and the user is in the moving exercise state, when the GPS moving speed is sufficiently fast, it is considered that the user is in the vehicle and “running” or “walking” (for example, walking in a train). Accordingly, the threshold value of the frequency of the variation cycle for the determination of whether or not the user is in the moving exercise state and the threshold value for the determination of the GPS moving speed may be set in advance, and the above-described case may be determined to be in the vehicle.

Then, when the user is not in the vehicle based on the result of the vehicle determination processing of Step a19 (Step a21: No), the moving speed output control unit 190 outputs the estimated moving speed as the moving speed of the user (Step a25). When it is determined to be in the vehicle (Step a21: Yes), the moving speed output control unit 190 outputs the GPS moving speed as the moving speed of the user (Step a23). Thereafter, single speed estimation processing ends.

With this processing, when the user is in the vehicle, it is possible to output the GPS moving speed as the moving speed of the user, instead of the estimated moving speed. When the user is not in the vehicle, it is possible to output the estimated moving speed as the moving speed of the user.

As described above, according to this embodiment, the scattering direction of the distribution of the acquired three-axis detected acceleration is analyzed by the principal component analysis, for example, the direction of the distribution of the top two principal components is separated and extracted, and the values, such as the variation cycle or variation intensity of the principal component direction, which has an influence on the moving speed can be acquired as the characteristic value in the distribution coordinate. Then, it is possible to estimate the moving speed of the user selectively using the moving speed relational expression for running or the moving speed relational expression for walking according to whether the state of the user is “running” or “walking” while learning and updating the moving speed relational expressions arbitrarily using the acquired characteristic value. Accordingly, it is possible to calculate the estimated moving speed as the moving speed specific to the state of the user, who is running, walking, or the like, with high precision.

In the above-described embodiment, the estimated moving speed is calculated using the moving speed relational expression for running and the moving speed relational expression for walking while learning and updating the moving speed relational expression for running and the moving speed relational expression for walking arbitrarily using the variation cycle and the variation intensity as the characteristic value. However, the characteristic value for use in the learning of the moving speed relational expression for running and the moving speed relational expression for walking is not limited to the two values. For example, a configuration in which at least one of the two values is used as the characteristic value may be made. Furthermore, other values correlated with the moving speed of the user may be further used, or a plurality of the values may be used as the characteristic value in combination.

In the above-described embodiment, speed and pitch information have been described as an example of the exercise amounts to be calculated. In addition, for example, a grounding index value, such as impact at the time of landing or a force when striking the ground may be calculated as one of the exercise amounts using the power of autocorrelation found based on the variation cycle of the value of the detected acceleration and displayed and output.

In the above-described embodiment, although the wrist mounting running watch 1 has been illustrated as the portable apparatus including the exercise amounts calculation device, the invention is not limited thereto, and for example, the invention may be realized as a portable apparatus which is used in a state of being mounted on another part of the four limbs of the user, for example, an ankle or an upper arm. The mounting part of the portable apparatus is not limited to the four limbs of the user, and may be an arbitrary position of the body. For example, the portable apparatus may be mounted on a waist through a belt.

The satellite signal for positioning is not limited to the GPS satellite signal, and a configuration in which a satellite signal for positioning of a wide area augmentation system (WAAS), a quasi zenith satellite system (QZSS), a global navigation satellite system (GLONASS), GALILEO, or the like is used may be made.

The entire disclosure of Japanese Patent Application Nos. 2013-229329, filed Nov. 5, 2013 and 2014-160180, filed Aug. 6, 2014 are expressly incorporated by reference herein.

What is claimed is:

1. An exercise amounts calculation method comprising:
finding a first direction appearing in the distribution of a detected acceleration by an acceleration sensor which configured to be worn on a body of a user; and
calculating exercise amounts during a moving exercise of the user using a variation cycle of the value of the detected acceleration along the first direction.

2. The exercise amounts calculation method according to claim 1, further comprising:
autocorrelating a plurality of values of the detected acceleration varying along the first direction to calculate the variation cycle.

3. The exercise amounts calculation method according to claim 2,
wherein the autocorrelating includes performing predetermined frequency analysis processing and performing predetermined inverse frequency analysis processing.

4. The exercise amounts calculation method according to claim 1,
wherein the finding of the first direction includes finding the first direction based on a scattering direction of the distribution of the detected acceleration.

5. The exercise amounts calculation method according to claim 4,
wherein the finding of the first direction includes finding the first direction based on one of a maximum scattering direction of the distribution of the detected acceleration and a scattering direction orthogonal to the maximum scattering direction.

6. The exercise amounts calculation method according to claim 1,
wherein the finding of the first direction includes finding the first direction which appears in the distribution of the detected acceleration for a predetermined unit time equal to or less than five seconds.

7. An exercise amounts calculation device comprising:
a determination unit which finds a first direction appearing in the distribution of a detected acceleration by an acceleration sensor which configured to be worn on a body of a user; and
a calculation unit which calculates exercise amounts during a moving exercise of the user using a variation cycle of the value of the detected acceleration along the first direction.

8. The exercise amounts calculation device according to claim 7,
wherein the acceleration sensor is worn on one of the four limbs of the user.

9. A portable apparatus comprising:
the exercise amounts calculation device according to claim 7.

10. A portable apparatus comprising:
the exercise amounts calculation device according to claim 8.
